(19) United States
(12) Patent Application Publication
(10) Pub. No.: US 2026/0155701 A1
(43) Pub. Date: Jun. 4, 2026

(54) OUTER ROTOR TYPE MOTOR

(71) Applicant: SHINANO KENSHI KABUSHIKI KAISHA, Nagano (JP)

(72) Inventor: Shun TAKAYAMA, Nagano (JP)

(21) Appl. No.: 19/381,829

(22) Filed: Nov. 6, 2025

(30) Foreign Application Priority Data
Dec. 3, 2024 (JP) 2024-210053

(51) Int. Cl. H02K 5/173; F16C 25/08; H02K 1/2786

(52) U.S. Cl. CPC H02K 5/173; F16C 25/08; H02K 1/2786; F16C 2360/46; F16C 2380/26

(57) ABSTRACT

A pre-loading spring is fitted on an outer circumference of a rotor shaft between a hub of a rotor yoke and a bearing disposed opposite the hub in an axial direction, and is mounted so as to be compressed shorter than its equilibrium length. The preloading spring is a compression coil spring, and is wound in a direction relative to a direction of rotation of the rotor yoke so that a winding end does not interfere with driven rotation.

### CROSS-REFERENCE TO RELATED APPLICATION

This application is based upon and claims the benefit of priority of the prior Japanese Patent Application No. 2024-210053, filed on December 3, 2024, and the entire contents of which are incorporated herein by reference.

### TECHNICAL FIELD

The present disclosure relates to an outer rotor type motor used as a driving source for a vehicle-mounted device or a HVAC (Heating, Ventilation, and Air Conditioning) device, for example.

### BACKGROUND ART

Outer rotor-type axial fan motors, for example, are susceptible to external forces acting on the side of the blower, which is assembled on the rotor yoke. If the rotor becomes displaced in the axial direction, there is the risk of damage to the bearings that rotatably support the rotor shaft, the insulator that covers the stator core, and the like. For this reason, a pre-loading spring (a "coil spring") is provided between a rolling bearing (or "inner ring") and a boss of the rotor yoke. The pre-loading spring is fitted onto the outer circumference of the rotor shaft and is compressed beyond its equilibrium length, so that even if an external force acts from the blower side, the elasticity of the preloading spring will absorb the impact and prevent interference between the rotor and the stator (see Patent Document 1: Japanese Examined Patent Application Publication No. H06-1963).

### SUMMARY OF INVENTION

### Technical Problem

In the configuration described in Patent Document 1, the preloading spring (coil spring) is compressed and mounted between a rolling bearing (inner ring) and the boss of the rotor yoke. This means that when a fan rotates together with the rotor yoke, the preloading spring is also driven to rotate in synchronization. In more detail, the inner ring of the rolling bearing and the preloading spring are driven to rotate in synchronization with the rotor yoke and the rotor shaft.

When the rotational load on the rolling bearings has increased due to factors such as running marks being produced by the rollers in the pair of rolling bearings, the formation of lumps due to deterioration in the grease, or increased grease viscosity in a low-temperature environment (such as -40°C), the inner ring of the rolling bearing and the pre-loading spring will no longer rotate in synchronization with the rotor. When this happens and the direction in which the rotor is rotating is opposite to a winding end of the pre-loading spring, the winding end of the pre-loading spring will catch on the sliding surface with increased force, which produces abnormal noise. Scratches will also form on the boss of the rotor yoke and/or the end face of the rolling bearing contacted by the winding end of the coil spring, which reduces the lifespan of these components.

### Solution to Problem

The present disclosure was conceived to solve the problems described above and has an object of providing an outer rotor type motor which, by preventing a winding end of a pre-loading spring from catching on a sliding surface even when the rotational load of the rolling bearings that support the rotor shaft increases, has quieter operation due to the suppression of abnormal noise and extends the lifespan of components by suppressing the production of scratches.

To achieve the object stated above, the embodiment described below has the following configuration. That is, an outer rotor type motor includes: a stator on which stator poles are formed; a rotor on which rotor poles composed of a permanent magnet are disposed radially outside the stator to face the stator poles; a rotor shaft whose shaft end portion that is integrally assembled with a hub of a rotor yoke, which is cup-shaped; a pair of rolling bearings which are assembled inside a bearing housing provided in a motor housing and rotatably support the rotor shaft; and a pre-loading spring which is fitted between the hub of the rotor yoke and the rolling bearing disposed opposite the hub in an axial direction on an outer circumference of the rotor shaft, and is compressed to shorter than an equilibrium length thereof, wherein the pre-loading spring is a compression coil spring that is wound in a direction relative to a direction of rotation of the rotor yoke so that a winding end of the pre-loading spring does not interfere with driven rotation.

With the configuration described above, when the rotor rotates, the pre-loading spring (a compression coil spring) which is fitted in a compressed state between the hub of the rotor yoke and the rolling bearing disposed opposite the hub in the axial direction is driven to rotate in synchronization with the rotor. When this happens, since the winding end of the pre-loading spring is wound in a direction that does not interfere with the driven rotation that accompanies rotation of the rotor yoke, even if the rotational load of the pair of rolling bearings increases, the winding end of the compressed pre-loading spring does not strongly catch on the sliding surface of the rotor yoke or a rolling bearing, which suppresses the generation of abnormal noise and achieves quieter operation. In addition, even if the winding end of the pre-loading spring slides more strongly in contact with the boss of the rotor yoke or an end face of a rolling bearing, scratching is reduced, which can extend the lifespan of components.

In more detail, when the rotor yoke rotates clockwise in a plan view looking from one end in the axial direction of the rotor, the preloading spring is preferably wound counterclockwise, and when the rotor yoke rotates counterclockwise, the preloading spring is preferably wound clockwise. By doing so, even when the rotational load on the pair of rolling bearings increases, the winding end of the preload spring does not interfere with the driven rotation that accompanies rotation of the rotor yoke. This prevents the winding end from catching more strongly on the sliding surface of the hub of the rotor yoke or the rolling bearing, which can suppresses noise and achieve quieter operation and can also reduce scratching, thereby extending the lifespan of components. Note that in this specification, when the coil spring is viewed from one end, a coil wound counterclockwise from the start of winding (one end of the coil spring) is described as "counterclockwise" and a coil wound clockwise is described as "clockwise".

The preloading spring may be fitted onto an outer circumference of the rotor shaft between a hub of the rotor yoke and the inner ring of the rolling bearing disposed opposite the hub in the axial direction. By doing so, it is possible to minimize the outer diameter of the pre-loading spring and assemble the pre-loading spring with no rattling between the rotor yoke and the rolling bearings.

### Advantageous Effects of Invention

According to an aspect of the present disclosure, there is provided an outer rotor type motor which, by preventing a winding end of a pre-loading spring from catching on a sliding surface even when the rotational load of rolling bearings that support a rotor shaft increases, has quieter operation due to the suppression of abnormal noise and extends the lifespan of components by suppressing the production of scratches.

### BRIEF DESCRIPTION OF DRAWINGS

FIG. 1 is a perspective view of a centrifugal blower.

FIG. 2 is a perspective view of a state where a top housing of the centrifugal blower appearing in FIG. 1 has been removed.

FIG. 3 is a vertical cross-sectional view of principal parts of the centrifugal blower appearing in FIG. 1.

FIG. 4 is an enlarged cross-sectional view of the motor part in FIG. 3.

FIG. 5 is a diagram useful in explaining examples of a rotational direction of a rotor and a winding direction of a pre-loading spring.

FIG. 6 is a diagram useful in explaining other examples of the rotation direction of a rotor and the winding direction of a pre-loading spring.

FIG. 7 is a graph depicting the relationship between intensity and noise level (dB) for each frequency (Hz) when measured noise data has been subjected to a fast Fourier transform, for a case where the pre-loading spring is wound clockwise (Graph A) and counterclockwise (Graph B) when the rotor 3 rotates in the clockwise direction.

FIG. 8 is a photograph indicating a sliding part of the preloading spring corresponding to graph A in FIG. 7.

FIG. 9 is a photograph indicating a sliding part of a rotor yoke corresponding to graph A in FIG. 7.

FIG. 10 is a photograph indicating a sliding part of the preloading spring corresponding to graph B in FIG. 7.

FIG. 11 is a photograph indicating a sliding part of the rotor yoke corresponding to graph B in FIG. 7.

### DESCRIPTION OF EMBODIMENTS

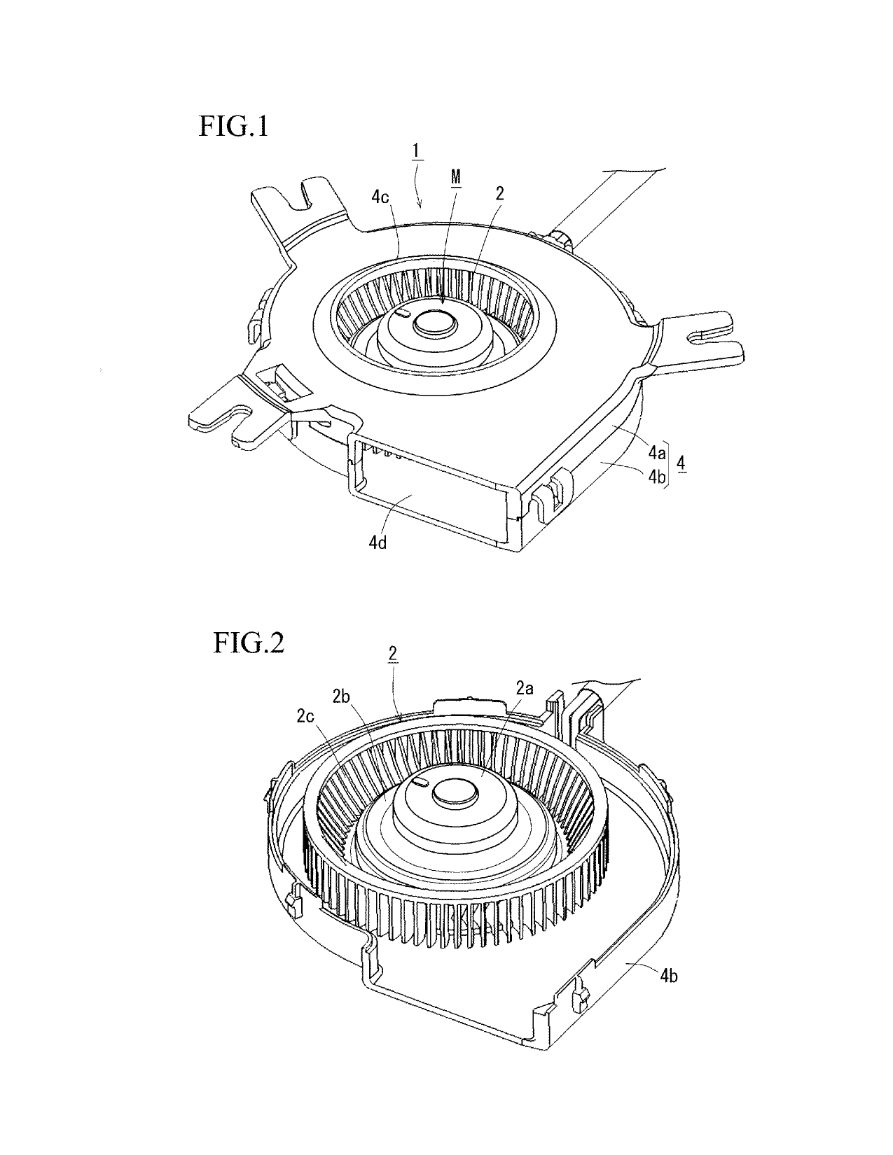

An embodiment of an outer rotor type motor according to the present invention is described below with reference to the accompanying drawings. First, the overall configuration of the outer rotor type motor will be described with reference to FIGS. 1 to 6. As one example, an outer rotor type motor M described here is a DC brushless motor used in a vehicle-mounted device. In the following description, a centrifugal blower 1 that uses the outer rotor type motor M as a driving source is described as an example.

In FIG. 1, the centrifugal blower 1 includes a centrifugal fan 2 and a rotor 3 that are integrally assembled, with the outer rotor type motor M that rotationally drives such components housed inside a blower housing 4. In FIG. 2, the blower housing 4 is formed by assembling a top housing 4a that covers the centrifugal fan 2 and a bottom housing 4b that rotatably supports the outer rotor type motor M (that is, the rotor 3 and a stator 5). An intake opening 4c is provided in the center of the top housing 4a, and air that is drawn in through this intake opening 4c and pressurized from the outside in the radial direction is expelled through an exhaust port 4d provided around the circumferential direction.

In FIG. 2, the centrifugal fan 2 includes a hub 2a integrally assembled with a rotor yoke 3a at the center in the radial direction. The centrifugal fan 2 is insert-molded with the rotor yoke 3a, with an upper surface portion of the rotor yoke 3a integrated with the hub 2a. A main plate 2b, which is continuous with the hub 2a, extends radially outward in a stepped form, and a plurality of impellers 2c, which are curved from the inside to the outside in the radial direction, are formed so as to be erected on this main plate 2b.

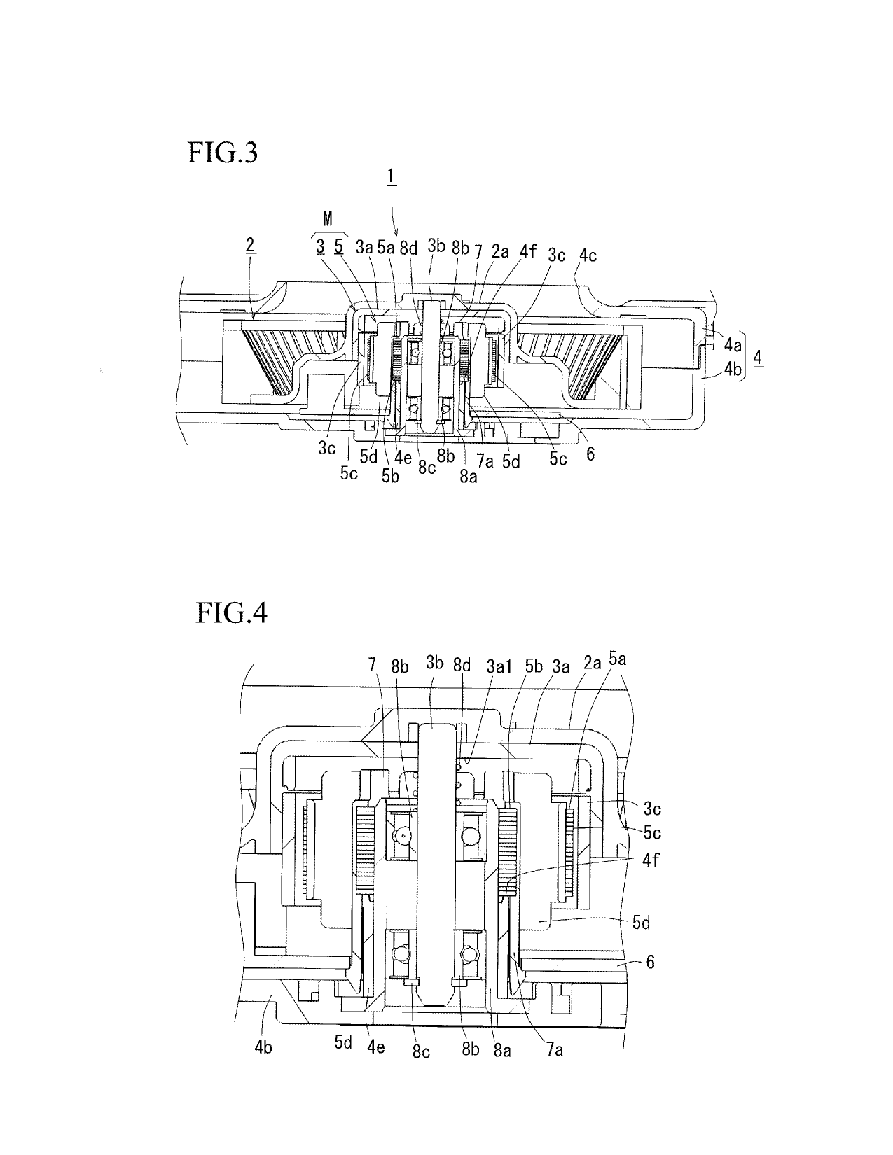

As depicted in FIG. 3, the outer rotor type motor M includes the rotor 3 and the stator 5. The rotor 3 includes a rotor shaft 3b attached to a hub of the rotor yoke 3a, which is cup-shaped. An annular rotor magnet 3c is provided on an inner circumferential surface of the rotor yoke 3a. The rotor magnet 3c is formed with rotor poles made of a permanent magnet that is magnetized with alternating north and south poles around the circumferential direction. The rotor 3 is assembled radially outside the stator 5 so that the rotor poles of the rotor magnet 3c face stator poles.

In FIG. 3, the stator 5 includes a plurality of pole teeth 5c that protrude radially outward from a core back part 5b of a stator core 5a, which is annular, with motor coils 5d being wound around these pole teeth 5c via an insulator 7 to form the stator poles. Although a single-phase coil is wound in the present embodiment, a three-phase coil or the like may also be used. The insulator 7 is also equipped with coil pins (not illustrated) at two locations that connect to a motor coil 5d. Coil leads that extend from the motor coil 5d are connected to the coil pins.

In FIG. 3, a bearing housing 8a in the form of a metal tube is insert-molded into the bottom housing 4b of the blower housing 4 and is integrally assembled onto a housing accommodation part 4e. An upper end 4f of the housing accommodation part 4e determines the assembly position of the stator core 5a (the core back part 5b). A pair of rolling bearings (or simply "bearings" 8b) are inserted into the cylindrical hole of the bearing housing 8a at both ends in the length direction of the bearing housing 8a. The rotor shaft 3b is inserted into the bearing housing 8a and is rotatably supported by the pair of bearings 8b. A retaining washer 8c is fitted onto a shaft end of the rotor shaft 3b, which restricts axial movement by the bearing 8b at the lower end in the axial direction.

In FIG. 3, the motor substrate 6 is fixed to the blower housing 4 (the bottom housing 4b). Coil pins (not illustrated) that connect to the motor coils 5d wound around the pole teeth 5c of the stator core 5a are inserted into and soldered to substrate terminal holes. The motor substrate 6 is provided with a magnetic pole detection element (not illustrated), such as a Hall IC, for detecting magnetic pole positions of the rotor 3. The magnetic pole detection element detects magnetic pole positions of the rotor 3 and switches the direction of current flowing through the motor coil 5d, thereby causing the rotor 3 to rotate. Note that in a sensorless motor, the magnetic pole detection element may be omitted.

As depicted in FIG. 3, the stator core 5a is assembled on the insulator 7 by integral molding. The insulator 7 is formed by insert molding the stator core 5a using PBT (polybutylene terephthalate) resin, for example. Note that it is also possible to mold the insulator 7 separately and then assemble the insulator 7 in the periphery of the pole teeth 5c of the stator core 5a without using insert molding.

Tubular parts 7a are erected on both sides in the axial direction at positions radially inside the stator core 5a of the insulator 7. As described below, the motor substrate 6 is assembled onto one of these tubular parts 7a (see FIG. 4). The stator 5 and the motor substrate 6 (or "stator assembly") are assembled onto the bottom housing 4b by concentrically fitting the tubular part 7a onto the outer circumference of the housing accommodation part 4e, which houses the bearing housing 8a that is in the form of a metal tube (see FIG. 2).

Also, as depicted in FIG. 4, to enhance the rotational stability of the rotor 3, a pre-loading spring 8d is fitted around the rotor shaft 3b between the hub 3a1 of the rotor yoke 3a and (the inner ring of) the upper bearing 8b disposed opposite the hub 3a1 in the axial direction in a state where the pre-loading spring 8d is compressed beyond its equilibrium length. This pre-loading spring 8d is a compression coil spring, and as described later, is wound in a direction relative to the rotational direction of the rotor yoke 3a so that a winding end 8d1 does not interfere with driven rotation. Note that since it is sufficient for the pre-loading spring 8d to be provided between the hub 3a1 and the bearing 8b, it is also possible for the pre-loading spring 8d to be provided between the outer ring of the bearing 8b and the hub 3a1. However, providing the pre-loading spring 8d between the inner ring of the bearing 8b and the hub 3a1 is effective since this minimizes the outer diameter of the pre-loading spring 8d and enables the pre-loading spring 8d to be assembled without any rattling between the rotor yoke 3a and the bearing 8b.

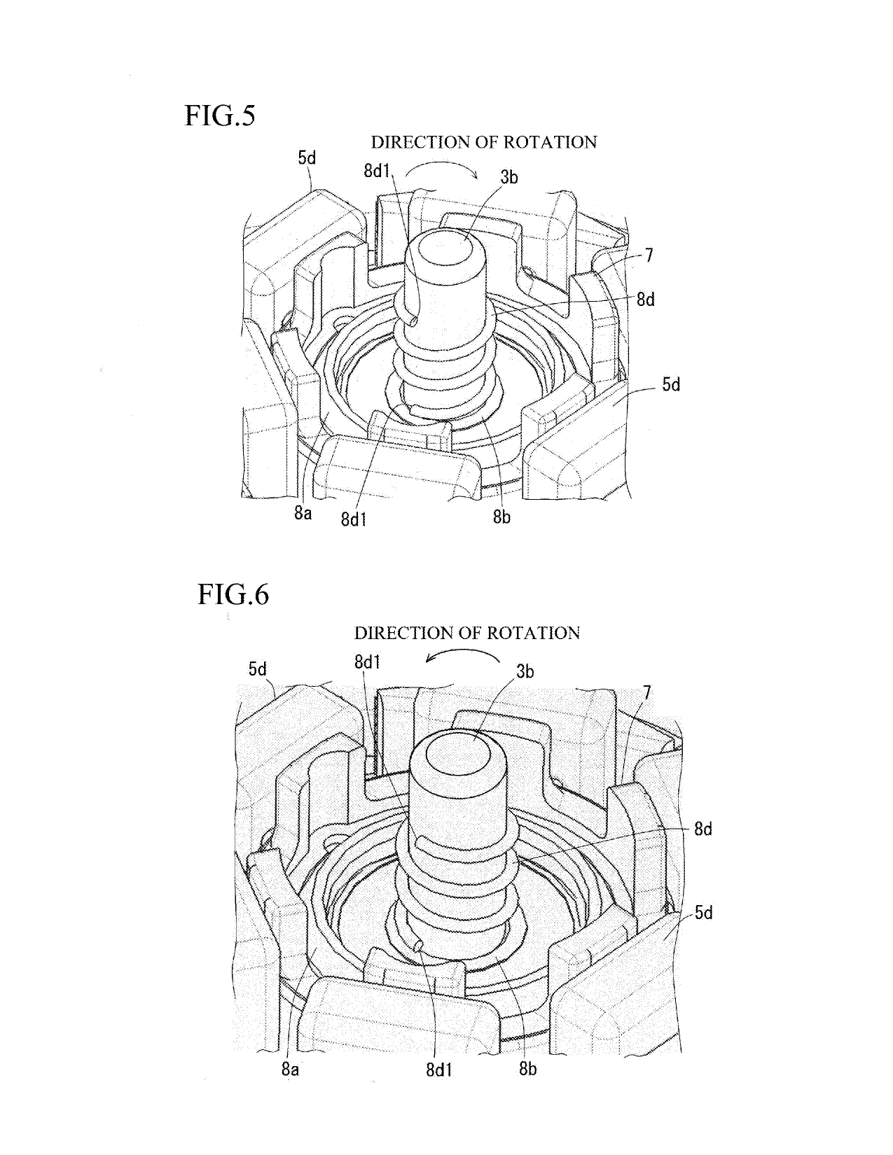

In more detail, as depicted in FIG. 5, when the rotor yoke 3a rotates counterclockwise when the rotor 3 is viewed in plan view from one end in the axial direction (here, the top end), it is desirable for the pre-loading spring 8d to be wound in the clockwise direction. Conversely, as depicted in FIG. 6, when the rotor yoke 3a rotates clockwise, it is desirable for the pre-loading spring 8d to be wound counterclockwise. As a result, even when the rotational load on the pair of bearings 8b has increased, the winding end 8d1 of the pre-loading spring 8d will not interfere with the driven rotation that accompanies the rotation of the rotor yoke 3a. This prevents the winding end 8d1 from strongly catching on the sliding surface of the hub 3a1 of the rotor yoke 3a or (the inner ring of) the bearing 8b, which can result in quieter operation due to the suppression of abnormal noise and can also extend the lifespan of components by suppressing the production of scratches.

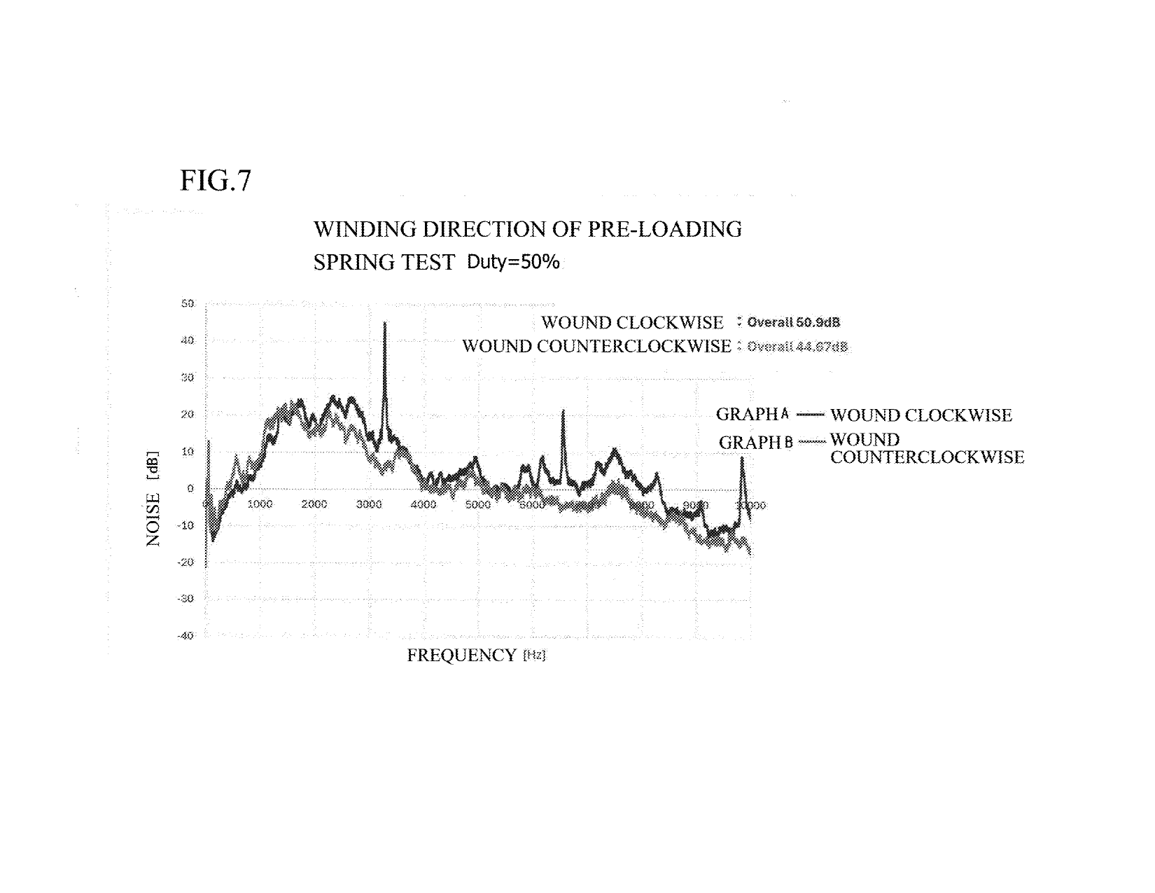

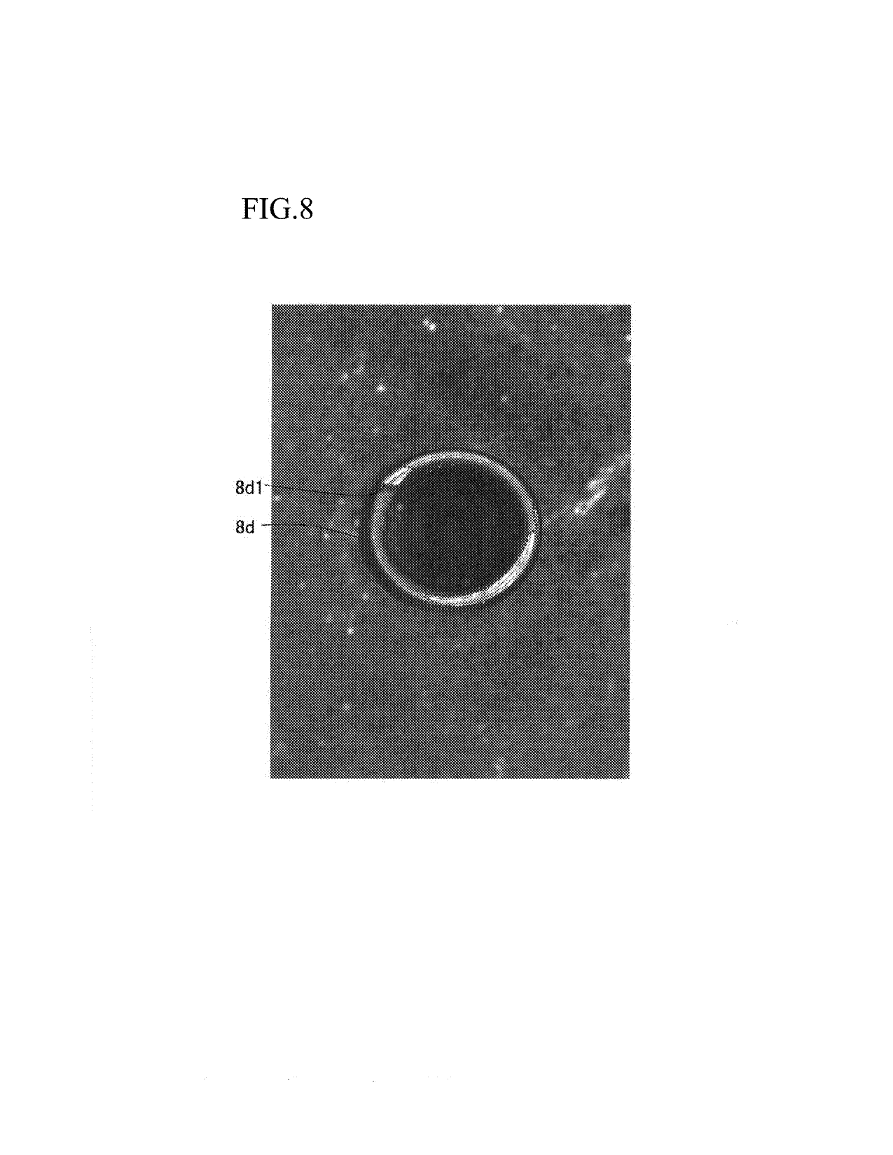

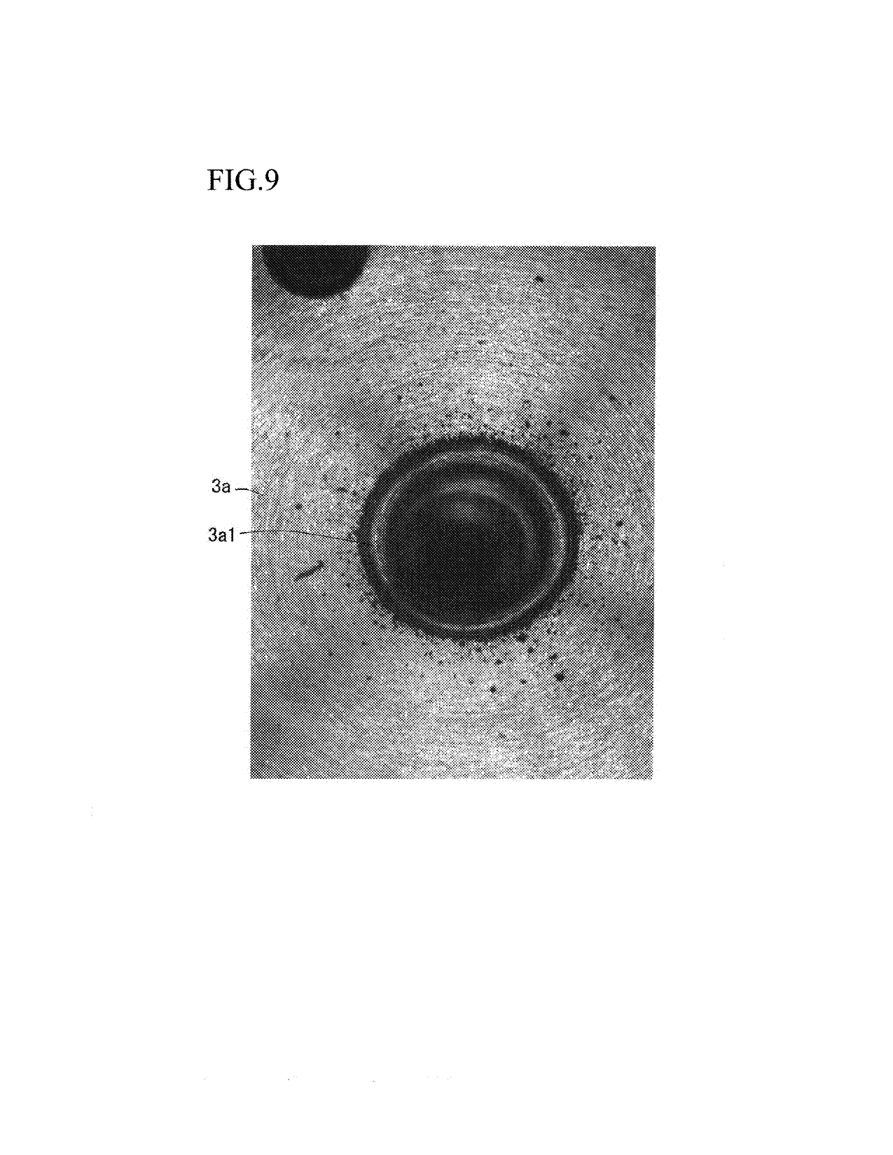

FIG. 7 is a graph depicting the relationship between noise intensity and noise level (dB) for each frequency (Hz) obtained by a fast Fourier transform of measured noise data when the preloading spring 8d is wound clockwise (Graph A) and counterclockwise (Graph B) for a case where the rotational direction of the rotor 3 is clockwise. Graph A in FIG. 7 indicates that when the preloading spring 8d is wound clockwise, the winding end 8d1 is likely to catch on the sliding surface of the hub 3a1 of the rotor yoke 3a and/or (the inner ring of) the bearing 8b. This results in the production of rotational order components of noise caused by the preloading spring 8d getting caught at a plurality of locations. FIGS. 8 and 9 are photographs indicating the pre-loading spring 8d and a sliding part (the hub 3a1) of the rotor yoke 3a corresponding to Graph A in FIG. 7. It can be understood that the sliding surface of the rotor yoke 3a (the hub 3a1) becomes deeply scratched and the winding end 8d1, which is pressed by and in sliding contact with the sliding surface, also becomes deeply scratched (see the areas surrounded by dashed lines in FIGS. 8 and 9).

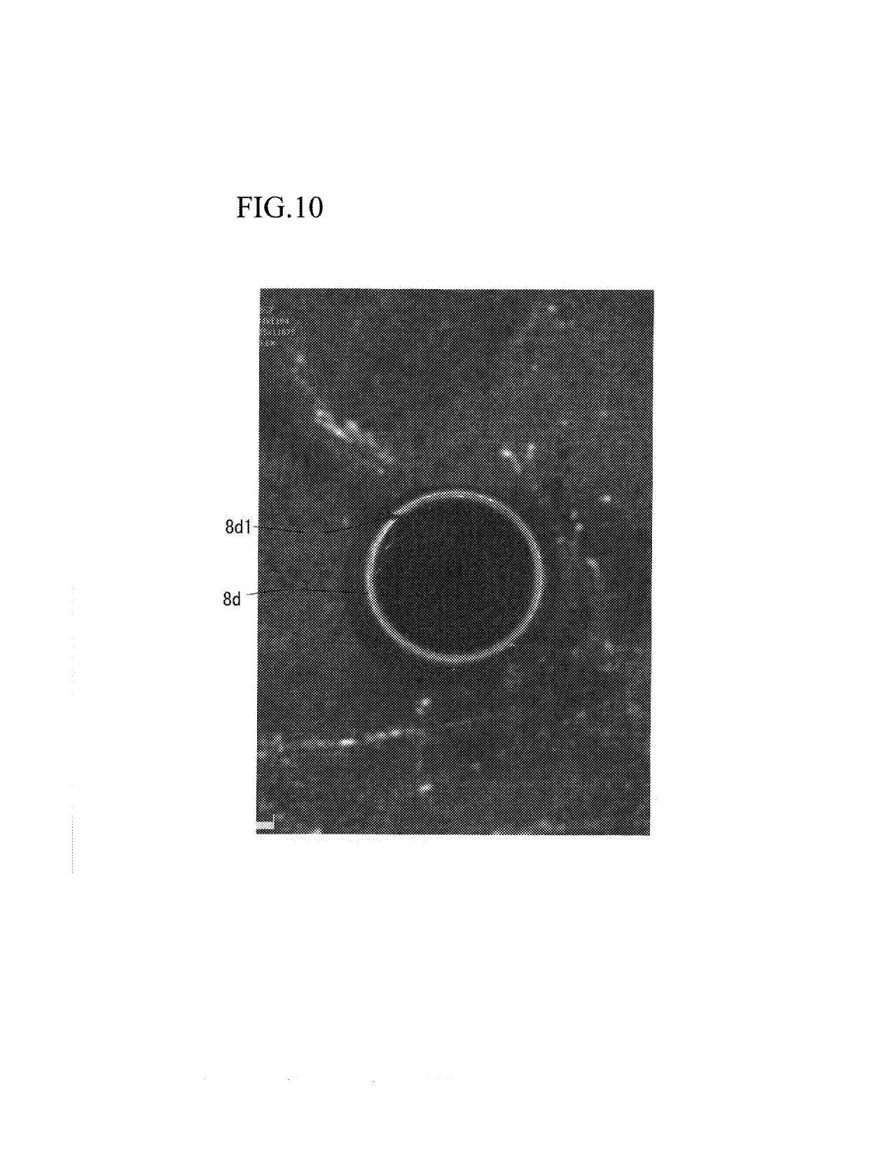

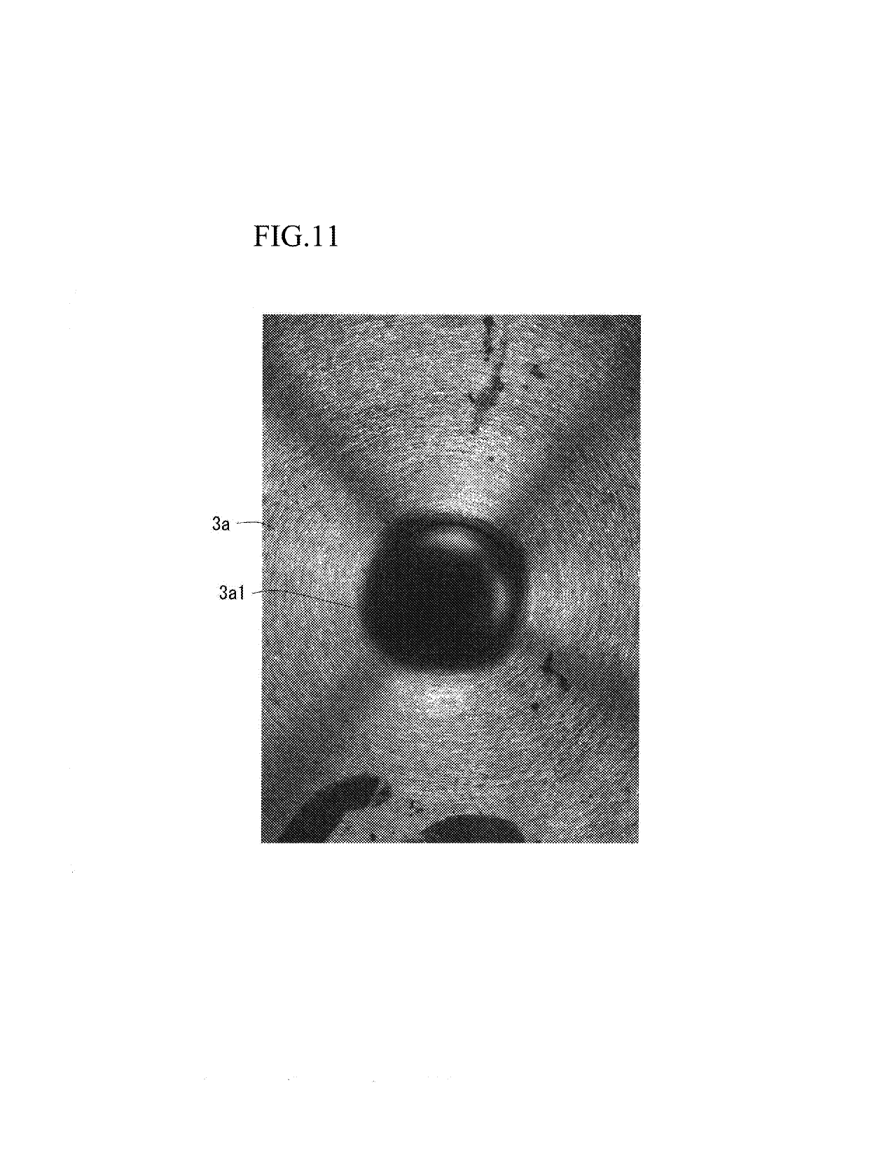

On the other hand, graph B in FIG. 7 indicates that when the pre-loading spring 8d is wound counterclockwise, since the winding end 8d1 is less likely to catch on the sliding surface of the hub 3a1 of the rotor yoke 3a and/or (the inner ring of) the bearing 8b, no peak noise (abnormal noise) is produced even when the rotation speed changes. FIGS. 10 and 11 are photographs indicating the preloading spring 8d and the sliding part (the hub 3a1) of the rotor yoke 3a. It can be understood that the sliding surface of the rotor yoke 3a (the hub 3a1) is only slightly scratched, and that the winding end 8d1, which is pressed by and in sliding contact with the sliding surface, is also only slightly scratched.

As described above, when the rotor 3 rotates, the preloading spring 8d, which is fitted between the hub 3a1 of the rotor yoke 3a and the bearing 8b that faces the hub 3a1 in the axial direction, is driven to rotate in synchronization. When this happens, since the preloading spring 8d is wound so that the winding end 8d1 does not interfere with the driven rotation that accompanies the rotation of the rotor yoke 3a, even if the rotational load on the pair of bearings 8b increases, the winding end 8d1 of the spring 8d, which is compressed, does not strongly catch on the sliding surface of the rotor yoke 3a or the bearing 8b, which suppresses the production of abnormal noise and results in quieter operation. Even if the sliding between the winding end 8d1 of the pre-loading spring 8d and the hub 3a1 of the rotor yoke 3a or an end surface of (the inner ring of) the bearing 8b becomes stronger, scratching is reduced, which extends the lifespan of components.

Although a magnetic pole detection element 6a, such as a Hall IC, is provided on the motor substrate 6 in the embodiment described above, the present invention may be applied to a sensorless DC brushless motor in which the magnetic pole detection element 6a is omitted. The insulator 7 does not have to be integrally molded with the stator core 5a, and may be molded separately and then assembled.

What is claimed is:

1. An outer rotor type motor, comprising:
a stator on which stator poles are formed;
a rotor on which rotor poles composed of a permanent magnet are disposed radially outside the stator to face the stator poles;
a rotor shaft whose shaft end portion that is integrally assembled with a hub of a rotor yoke, which is cup-shaped;
a pair of rolling bearings which are assembled inside a bearing housing provided in a motor housing and rotatably support the rotor shaft; and
a pre-loading spring which is fitted between the hub of the rotor yoke and the rolling bearing disposed opposite the hub in an axial direction on an outer circumference of the rotor shaft, and is compressed to shorter than an equilibrium length thereof,
wherein the pre-loading spring is a compression coil spring that is wound in a direction relative to a direction of rotation of the rotor yoke so that a winding end of the pre-loading spring does not interfere with driven rotation.

2. The outer rotor type motor according to claim 1,
wherein when the rotor yoke rotates clockwise in a plan view looking from one end in the axial direction of the rotor, the preloading spring is wound counterclockwise, and when the rotor yoke rotates counterclockwise, the preloading spring is wound clockwise.

3. The outer rotor type motor according to claim 1,
wherein the preloading spring is fitted onto the outer circumference of the rotor shaft between the hub of the rotor yoke and an inner ring of the rolling bearing disposed opposite to the hub in the axial direction.

4. The outer rotor type motor according to claim 2,
wherein the preloading spring is fitted onto the outer circumference of the rotor shaft between the hub of the rotor yoke and an inner ring of the rolling bearing disposed opposite to the hub in the axial direction.
